(19) United States
(12) Patent Application Publication
(10) Pub. No.: US 2017/0199038 A1
(43) Pub. Date: Jul. 13, 2017

(54) FLIGHT GUIDANCE SYSTEM

(71) Applicants: NIPPON SOKEN, INC., Nishio-city (JP); DENSO CORPORATION, Kariya-city (JP)

(72) Inventors: Hiroyasu BABA, Nishio-city (JP); Koji KAWASAKI, Nishio-city (JP); Takenori MATSUE, Nishio-city (JP)

(21) Appl. No.: 15/401,130

(22) Filed: Jan. 9, 2017

(30) Foreign Application Priority Data
Jan. 12, 2016 (JP) 2016-003496

(51) Int. Cl. G01C 21/00; B64D 43/00; B64C 27/08; G05D 1/00

(52) U.S. Cl. CPC G01C 21/00; G05D 1/00; B64D 43/00; B64C 27/08; B64C 39/024

(57) ABSTRACT

A flight guidance system is provided which includes an aerial vehicle unit and a navigation display unit. In use, the navigation display unit is placed on the ground, a wall, a ceiling, or a floor of a structural object and indicates navigation information for the aerial vehicle unit. The aerial vehicle unit optically reads the navigation information out of the navigation display unit to determine an installation position where the navigation display unit is disposed and also determine a flight position thereof based on the installation position. This enables the aerial vehicle unit to continue to fly along a given flight route without need for complicating the structure and operation thereof in an area where it is difficult for the aerial vehicle unit to receive navigation signals such as GPS signals.

### CROSS REFERENCE TO RELATED DOCUMENT

The present application claims the benefit of priority of Japanese Patent Application No. 2016-3496 on Jan. 12, 2016, the disclosure of which is incorporated herein by reference.

### BACKGROUND

1 Technical Field

The invention relates generally to a flight guidance system for an aerial vehicle.

2 Background Art

Recently, unmanned aerial vehicles called drones have become popular. Use of the drones makes it possible to check or search structural objects or natural environments into which persons could not enter up to now. Such a type of unmanned aerial vehicles usually receive GPS signals to be guided. There is, however, a problem that the guidance may fail when the aerial vehicle flies in a space such as inside of buildings or tunnels, or beneath bridge beams where it is difficult for GPS signals to penetrate. In order to alleviate this problem, Japanese Patent First Publication No. 2006-51864 teaches visually tracking a marker attached to an aerial vehicle to determine a location of the aerial vehicle. Specifically, this system uses a plurality of cameras mounted on the ground to capture images of the marker of the aerial vehicle and calculates the location or attitude of the aerial vehicle using the captured images.

The above system needs a plurality of cameras on the ground and a processor to process the images of the marker captured by the cameras, thus resulting in an increased overall size of the system. It is also difficult to quickly process the captured images in a simple way.

### SUMMARY

It is therefore an object to provide a flight guidance system which is mounted in an aerial vehicle and works to accurately calculate a location thereof in a space where it is hard for navigation signals such as GPS signals to reach without complicating the structure and operation thereof.

According to one aspect of this disclosure, there is provided a flight guidance system which comprises: (a) an aerial vehicle unit which is equipped with a plurality of thrusters working to produce propulsive power; (b) a navigation display unit which is physically separate from the aerial vehicle unit to be disposed on the ground, a wall, a ceiling, or a floor of a constructional object; (c) an information reader which is installed in the aerial vehicle unit and works to optically acquire information indicated by the navigation display unit when the aerial vehicle unit is flying; (d) a position determiner which is installed in the aerial vehicle unit and works to analyze the information, as read out by the information reader, to determine an installation position where the navigation display unit is placed, the position determiner also analyzing the installation position to determine a flight position of the aerial vehicle unit; and (e) a flight controller which is installed in the aerial vehicle unit and works to analyze the flight position to control autonomous flight of the aerial vehicle unit.

Specifically, the aerial vehicle unit functions to read out the information indicated by the navigation display unit placed on the ground, the wall, the ceiling, or the floor to determine its own location. The aerial vehicle unit continues to fly using the information read out of the navigation display unit. It is, therefore, possible for the aerial vehicle unit to locate the position thereof while flying even in an area where it is difficult to receive navigation signals such as GPS signals without need for complicating the structure and operation thereof.

### BRIEF DESCRIPTION OF THE DRAWINGS

The present invention will be understood more fully from the detailed description given hereinbelow and from the accompanying drawings of the preferred embodiment of the invention, which, however, should not be taken to limit the invention to the specific embodiment but are for the purpose of explanation and understanding only.

In the drawings:

FIG. 1 is a schematic perspective diagram which illustrates a flight guidance system according to an embodiment;

FIG. 2 is a schematic side diagram which illustrates the flight guidance system of FIG. 1;

FIG. 3 is a block diagram which shows an internal structure of an aerial vehicle unit of the flight guidance system of FIG. 1;

FIG. 4 is a schematic perspective diagram which illustrates a flight guidance system in a modified form of an embodiment;

FIG. 5 is a schematic perspective diagram which illustrates a flight guidance system in the second modified form of an embodiment; and

FIG. 6 is a schematic perspective diagram which illustrates a flight guidance system in the third modified form of an embodiment.

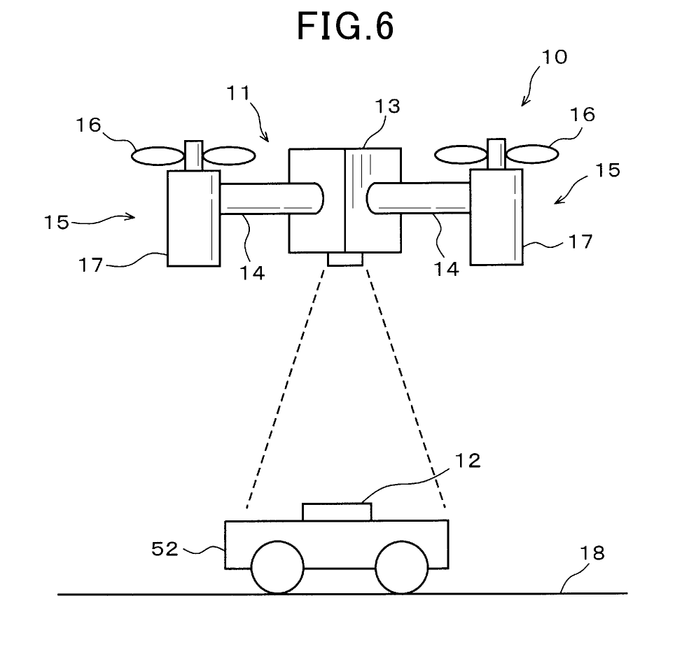

### DESCRIPTION OF THE PREFERRED EMBODIMENT

An embodiment of a flight guidance system 10 will be described below with reference to the drawings.

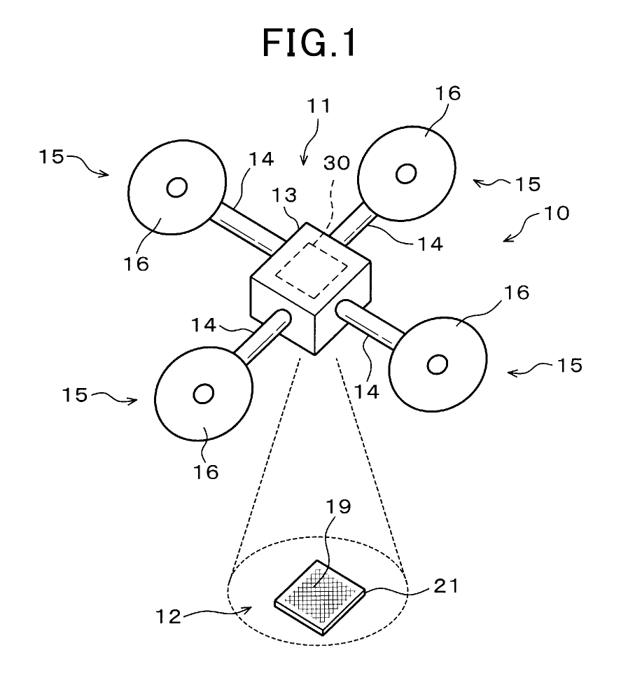

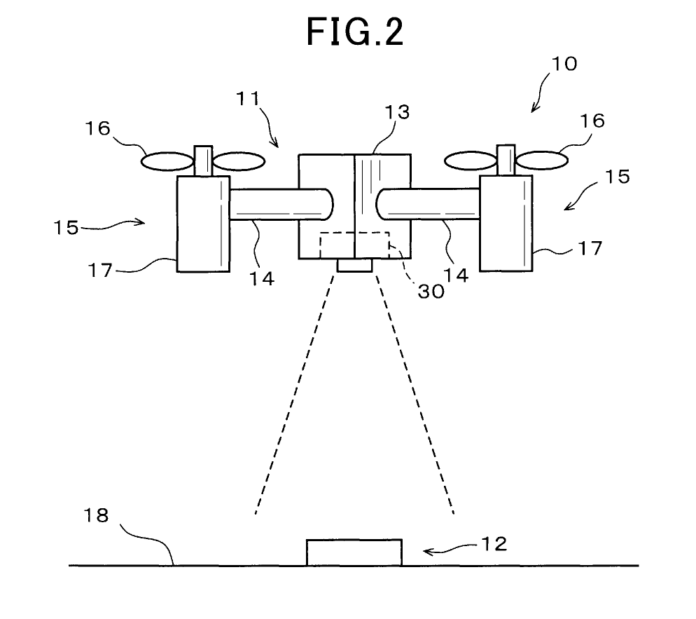

The flight guidance system 10, as clearly illustrated in FIGS. 1 and 2, includes the aerial vehicle unit 11 and the navigation display unit 12. The aerial vehicle unit 11 is equipped with the vehicle body 13 and the arms 14. The vehicle body 13 is located at the center of gravity of the aerial vehicle unit 11. The arms 14 extend outwardly from the vehicle body 13. In this embodiment, the aerial vehicle unit 11 is equipped with the four arms 14 arranged at equal intervals away from each other in a circumferential direction of the vehicle body 13. The number of the arms 14 is not limited to four as long as it is two or more.

The aerial vehicle unit 11 is equipped with the thrusters 15. Each of the thrusters 15 is secured to one end of a corresponding one of the arms 14 which is opposite the other end to which the vehicle body 13 is joined. Each of the thrusters 15 is equipped with the propellers 16 and the electric motor 17 which rotates the propellers 16. Each of the thrusters 15 works to rotate the propellers 16 using torque, as produced by the motor 17, to generate propulsive power of the aerial vehicle unit 11.

The navigation display unit 12 is physically separate from the aerial vehicle unit 11. The navigation display unit 12 is placed at a location, such as a surface of a floor of a structural object or a surface of the ground, which is visually perceived from the aerial vehicle unit 11 during flight. In this embodiment, the navigation display unit 12 is mounted on the ground surface 18. The navigation display unit 12 is used as a marker indicating information. Specifically, the navigation display unit 12 indicates information about instructions for the aerial vehicle unit 11 in the form of image 19 shown in FIG. 1. The image 19 is formed by, for example, a two-dimensional code which is printed on the display panel 21 of the navigation display unit 12. In this embodiment, the navigation display unit 12 is placed on the ground, a wall, a ceiling, or a floor and may be carried to another place as required. The image 19 indicated by the navigation display unit 12 is not limited to a two-dimensional code, but may be formed by a selected kind of graphic such as an arrow which represents a direction of flight of the aerial vehicle unit 11.

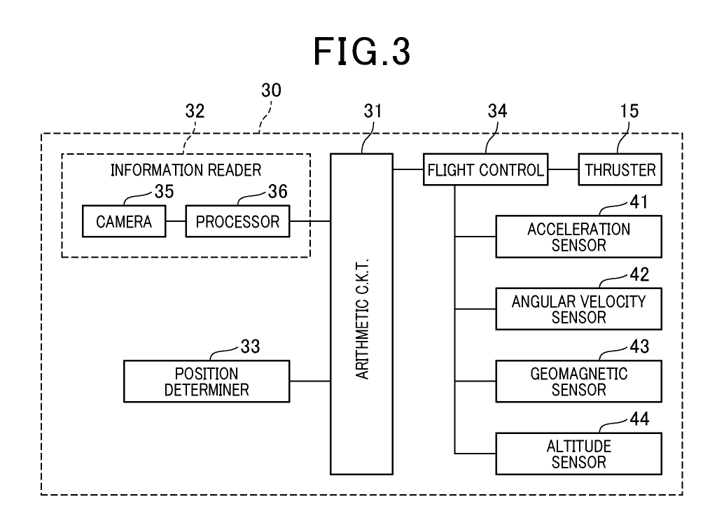

The aerial vehicle unit 11 is equipped with the control unit 30. The control unit 30 is disposed inside the vehicle body 13. The control unit 30 is, as illustrated in FIG. 3, equipped with the arithmetic circuit 31. The arithmetic circuit 31 is implemented by, for example, a typical microcomputer equipped with a CPU, a ROM, and a RAM. The control unit 30 executes computer programs stored in the ROM of the arithmetic circuit 31 to create the information reader 32, the information reader 32, the position determiner 33, and the flight controller 34 in a software form. The information reader 32, the position determiner 33, and the flight controller 34 may alternatively be realized by hardware or a combination of software and hardware.

The information reader 32 optically acquires the information on the navigation display unit 12. Specifically, the information reader 32 includes the camera 35 and the processor 36. The processor 36 is created by software, hardware, or a combination thereof. The camera 35 is implemented by, for example, a digital video camera or a digital still camera and works to capture information indicated on the navigation display unit 12 placed on the ground, the wall, the ceiling, or the floor. For instance, in a case where the navigation display unit 12 indicates the image 19 in the form of a two-dimensional code, the camera 35 captures an image of the two-dimensional code and outputs electrical data on the two-dimensional code to the processor 36. The processor 36 works to process the electrical data. The information reader 32 then acquires the information represented by the image 19 on the navigation display unit 12.

The position determiner 33 uses the information indicated by the image 19 obtained by the information reader 32 to derive installation position information and a flight position. Specifically, the image 19 shown by the navigation display unit 12 has the installation position information representing the location where the navigation display unit 12 is installed. The position determiner 33 analyzes the installation position information in the image 19 to determine the position of the navigation display unit 12. The installation position information has absolute position information about degrees of longitude and latitude of the navigation display unit 12, but may alternatively have relative position information representing the location of the navigation display unit 12 relative to a reference position set as a flight start point of the aerial vehicle unit 11. The reference position may be stored in a ROM or a RAM of the arithmetic circuit 31 or acquired from the image 19 shown by the navigation display unit 12. In this way, the position determiner 33 uses the information, acquired by the information reader 32 from the navigation display unit 12, to determine the position where the navigation display unit 12 is placed. The position determiner 33 also derives the flight position of the aerial vehicle unit 11. In the case where the position determiner 33 derives the absolute position of the navigation display unit 12 from the installation position information, the position determiner 33 calculates the flight position of the aerial vehicle unit 11. Alternatively, in the case where the position determiner 33 derives the relative position of the navigation display unit 12 from the installation position information, the position determiner 33 uses the position information, as obtained from the navigation display unit 12, and the reference position to calculate the flight position of the aerial vehicle unit 11.

The flight controller 34 acquires a flight attitude and a flight altitude of the aerial vehicle unit 11 and controls an output power of each of the thrusters 15 of the aerial vehicle unit 11 to head the aerial vehicle unit 11 along a preselected flight route. Specifically, the flight controller 34 connects with the acceleration sensor 41, the angular velocity sensor 42, the geomagnetic sensor 43, and the altitude sensor 44. The flight controller 34 analyzes outputs from the acceleration sensor 41 and the angular velocity sensor 42 of the aerial vehicle unit 11 to determine the flight attitude of the aerial vehicle unit 11. Additionally, the flight controller 34 analyzes an output from the geomagnetic sensor 43 to calculate the flight direction of the aerial vehicle unit 11 and also analyzes an output from the altitude sensor 44 to determine the flight altitude of the aerial vehicle unit 11. The flight controller 34 uses the flight position of the aerial vehicle unit 11, as derived by the position determiner 33, the flight attitude, and the flight altitude, as obtained from the outputs of the above sensors, to control the output power of the thrusters 15, thereby achieving autonomous flight of the aerial vehicle unit 11 along the preselected flight route while controlling the flight altitude and the flight attitude thereof based on the information derived by the position determiner 33 from the navigation display unit 12 and the flight position of the aerial vehicle unit 11, as determined based on the derived information.

In the above way, the information reader 32 installed in the aerial vehicle unit 11 optically acquires the information indicated by the navigation display unit 12 which is physically separate from the aerial vehicle unit 11. In other words, the information reader 32 is designed to read the information out of the image 19 on the navigation display unit 12 which is separate from the aerial vehicle unit 11 and placed on the ground, a wall, a ceiling, or a floor of a structural object. The position determiner 33 installed in the aerial vehicle unit 11 uses the position of the navigation display unit 12 and the information read from the navigation display unit 12 to determine the flight position of the aerial vehicle unit 11. The flight controller 34 installed in the aerial vehicle unit 11 uses the flight position, as derived by the position determiner 33, to control the flight of the aerial vehicle unit 11. In this way, the aerial vehicle unit 11 determines its position from the information, as read by the information reader 32 out of the image 19 indicated on the navigation display unit 12, and continues to fly. In other words, the aerial vehicle unit 11 uses the information derived from the navigation display unit 12 in a simple data reading operation to realize the flight thereof. It is, therefore, possible for the aerial vehicle unit 11 to acquire the position itself and continue to fly in airspace where it is difficult to receive navigation signals such as GPS signals without complicating the structure and operation of the flight guidance system.

The aerial vehicle unit 11 is, as described above, equipped with the camera 35 to optically obtain the information from the navigation display unit 12. As the camera 35, one may be used which is originally installed in the aerial vehicle unit 11 for use in checking or inspecting a target object to be tracked. This enables the information to be obtained from the navigation display unit 12 without need for installation of an additional equipment in the aerial vehicle unit 11, thereby realizing autonomous flight of the aerial vehicle unit 11 without need for complicating the structure thereof or increasing the weight thereof.

### Modifications

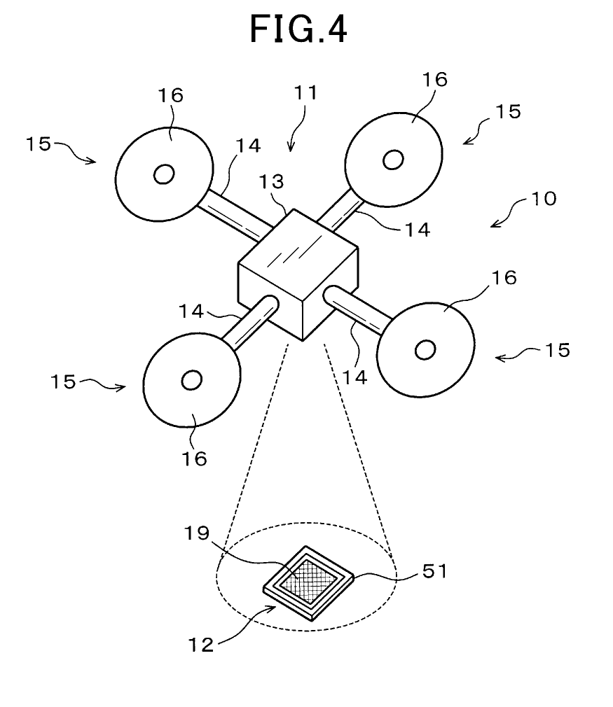

The navigation display unit 12 is, as described above, made in the shape of a plate on which a two-dimensional code is displayed as the image 19, but may alternatively be designed to include, as illustrated in FIG. 4, a tablet type optical display 51 for presentation of the image 19.

For instance, the display 51 is made of liquid crystal or organic EL. Use of such a type of the display 51 enables the information provided from the navigation display unit 12 to the aerial vehicle unit 11 to be changed as needed. The display 51 may illuminate the image 19 represented by the navigation display unit 12, thereby ensuring the stability in reading the information represented by the image 19 out of the navigation display unit 12 even when the aerial vehicle unit 11 is in a dark place such as the inside of a structural object.

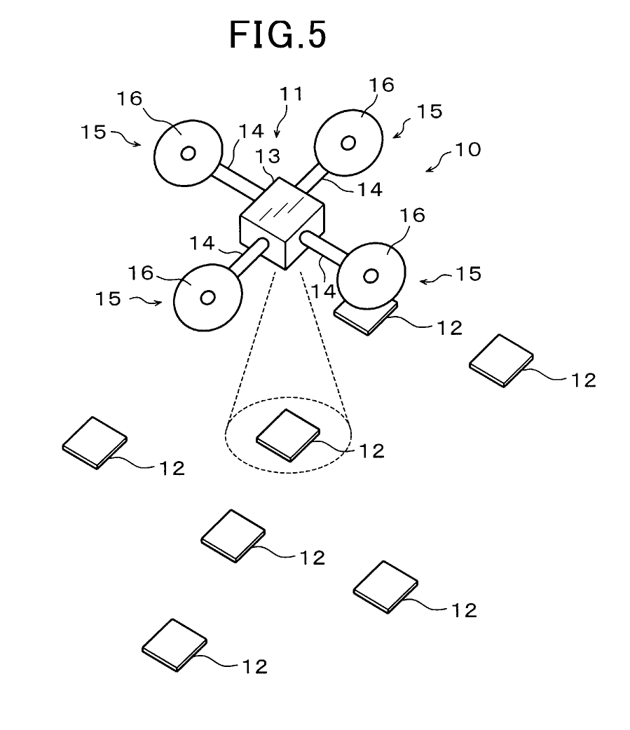

The above embodiment refers to an example where the single navigation display unit 12 is disposed, for example, at a reference place for flight, but two or more navigation display units 12 may be, as illustrated in FIG. 5, used. Specifically, the aerial vehicle unit 11 may be engineered to intermittently acquire pieces of information indicated on a plurality of navigation display units 12. For instance, the navigation display units 12 are placed at selected points such as junctions of flight routes or where the flight route should be changed. The aerial vehicle unit 11 obtains the information from the navigation display unit 12 placed at each of the selected points. This enables the aerial vehicle unit 11 to receive suitable instructions from the navigation display units 12 and ensures the stability in flight of the aerial vehicle unit 11 along a complicated flight route without any risk of departure therefrom.

The above embodiment refers to the example where the navigation display unit 12 is placed on the ground, a wall, a ceiling, or a floor of a structural object, but, the navigation display unit 12 may alternatively be designed to be movable on the ground, the wall, the ceiling, or the floor.

For instance, the navigation display unit 12 may be mounted on mobile equipment such as an automotive vehicle 52. When the vehicle 52 moves, the aerial vehicle unit 11 is navigated by the navigation display unit 12 along a selected flight route. Specifically, the aerial vehicle unit 11 moves while optically reading the information indicated by the navigation display unit 12 mounted on the vehicle 52.

The navigation display unit 12 may be disposed in an area where the aerial vehicle unit 11 is prohibited from entering. For instance, the navigation display unit 12 indicates an image representing a restricted area. When the information reader 32 of the aerial vehicle unit 11 obtains the image “restricted area” indicated on the navigation display unit 12, the flight controller 34 stops the aerial vehicle unit 12 from flying beyond the navigation display unit 12. The use of the navigation display unit 12, therefore, enables the aerial vehicle unit 11 to be inhibited from entering a no-fly zone.

While the present invention has been disclosed in terms of the preferred embodiment in order to facilitate better understanding thereof, it should be appreciated that the invention can be embodied in various ways without departing from the principle of the invention. Therefore, the invention should be understood to include all possible embodiments and modifications to the shown embodiment which can be embodied without departing from the principle of the invention as set forth in the appended claims.

What is claimed is:

1. A flight guidance system comprising:
an aerial vehicle unit which is equipped with a plurality of thrusters working to produce a propulsive power;
a navigation display unit which is physically separate from the aerial vehicle unit to be disposed on ground, a wall, a ceiling, or a floor of a constructional object;
an information reader which is installed in the aerial vehicle unit and works to optically acquire information indicated by the navigation display unit when the aerial vehicle unit is flying;
a position determiner which is installed in the aerial vehicle unit and works to analyze the information, as acquired by the information reader, to determine an installation position where the navigation display unit is placed, the position determiner also analyzing the installation position to determine a flight position of the aerial vehicle unit; and
a flight controller which is installed in the aerial vehicle unit and works to analyze the flight position to control autonomous flight of the aerial vehicle unit.

2. A flight guidance system as set forth in claim 1, wherein the information reader includes a camera configured to acquire the information in a form of an image indicated on the navigation display unit.
